(19) United States
(12) Patent Application Publication
(10) Pub. No.: US 2026/0148023 A1
(43) Pub. Date: May 28, 2026

(54) Mobile Computing Hand-Held Accessory

(71) Applicant: Zebra Technologies Corporation, Lincolnshire, IL (US)

(72) Inventor: Mu-Kai Shen, Taipei (TW)

(21) Appl. No.: 18/961,762

(22) Filed: Nov. 27, 2024

(51) Int. Cl. G06K 7/10; G06F 1/16

(52) U.S. Cl. CPC G06K 7/10366; G06F 1/1632

(57) ABSTRACT

A mobile computing accessory is disclosed. The mobile computing accessory comprises a housing having a first portion and a second portion. The first portion has a mounting mechanism extending from a first surface of the first portion and configured to receive a detachable computing device, and a tab extending from a second surface of the first portion to facilitate grasping the mobile computing accessory. The second surface opposes the first surface. The second portion has a radio frequency identification (RFID) antenna positioned within an interior thereof. The second portion extends at an acute angle from a proximal end of the first portion such that the housing is U-shaped. The acute angle by which the second portion extends from the proximal end of the first portion provides for viewing a scene via a display of the computing device mounted in the mounting mechanism while reading RFID tags present in the scene.

### BACKGROUND

A mobile hand-held terminal may be employed in several environments (e.g., retail, industrial, healthcare, or the like) to scan one or more indicia (e.g., one or more barcodes) or read one or more radio frequency identification (RFID) tags present in the environments. A terminal is assembled by enclosing internal electrical components within a housing to yield a form factor. For example, a terminal may have a “T” shaped form factor denoted by a brick or bar shaped element (e.g., a detachable or integrated computing device having one or more of a display, keypad and scan engine such as a laser scanner) positioned atop a handle having a trigger mechanism for actuating the terminal to scan one or more indicia. The “T” shaped form factor may also include a bib positioned at a distal end (e.g., an end furthest from a user) of the computing device where the bib is substantially parallel to the handle. The bib may have an RFID antenna positioned therein such that the trigger mechanism may actuate the terminal to read one or more RFID tags. This “T” shaped form factor is generally large and has a center of gravity proximate to the distal end of the computing device which can cause fatigue in the hand and wrist of a user. Additionally, the “T” shaped form factor prohibits a user from viewing a display of the computing device when scanning one or more indicia or reading one or more RFID tags.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates a perspective view of a mobile computing accessory in accordance with an embodiment of the present disclosure.

FIG. 2 illustrates a front view of the mobile computing accessory of FIG. 1.

FIG. 3 illustrates a rear view of the mobile computing accessory of FIG. 1.

FIG. 4 illustrates a side view of the mobile computing accessory of FIG. 1.

FIG. 5 illustrates another side view of the mobile computing accessory of FIG. 1.

FIG. 6 illustrates a bottom view of the mobile computing accessory of FIG. 1.

FIG. 7 illustrates a perspective view of a mobile computing accessory in accordance with another embodiment of the present disclosure.

FIG. 8 illustrates a side view of the mobile computing accessory of FIG. 7.

FIG. 9 illustrates a side view of the mobile computing accessory of FIG. 7.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The components of embodiments of the present disclosure have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

In an embodiment, the present disclosure is directed to a mobile computing accessory. The mobile computing accessory comprises a housing. The housing comprises a first portion and a second portion. The first portion has a mounting mechanism extending from a first surface of the first portion and configured to receive a detachable computing device, and a tab extending from a second surface of the first portion to facilitate grasping the mobile computing accessory. The second surface opposes the first surface. The second portion has a radio frequency identification (RFID) antenna positioned within an interior of the second portion. The second portion extends at an acute angle from a proximal end of the first portion such that the housing is U-shaped. The acute angle by which the second portion extends from the proximal end of the first portion provides for viewing a scene via a display of the computing device mounted in the mounting mechanism while reading one or more RFID tags present in the scene.

In accordance with an embodiment of the present disclosure, the first surface of the first portion has a recess configured to receive a battery.

In accordance with an embodiment of the present disclosure, the mounting mechanism has a first side wall, a second side wall, and a bottom wall that extend vertically from the first surface of the first portion. The first side wall has a first tab extending from a portion of the first side wall proximate to the proximal end of the first portion, the second side wall has a second tab extending from a portion of the second side wall proximate to the proximal end of the first portion, and the bottom wall has a third tab extending from a length of the bottom wall proximate to a distal end of the first portion.

In accordance with an embodiment of the present disclosure, the first portion has at least one of a printed circuit board, a heat sink, or a battery positioned within an interior of the first portion and the tab extends from the second surface of the first portion proximate to the proximal end of the first portion.

In accordance with an embodiment of the present disclosure, the acute angle by which the second portion extends from the proximal end of the first portion provides for an unobstructed field of view of an imaging assembly positioned on a posterior surface of a proximal end of the computing device when received by the mounting mechanism where the imaging assembly extends beyond the proximal end of the first portion.

In accordance with an embodiment of the present disclosure, the housing comprises a thermoplastic material.

In accordance with an embodiment of the present disclosure, the first portion has a distal end, the second portion has a distal end, and the distal end of the first portion and the distal end of the second portion stabilize the mobile computing accessory in an upright position when positioned on a horizontal planar surface.

In accordance with an embodiment of the present disclosure, the mobile computing accessory communicatively couples to the computing device when mounted in the mounting mechanism by at least one of wireless communication pairing or contact pins.

In accordance with an embodiment of the present disclosure, the computing device actuates the mobile computing accessory to read the one or more RFID tags present in the scene via a button presented on the display of the computing device.

In accordance with an embodiment of the present disclosure, the first portion has a trigger mechanism where the trigger mechanism is a depressible button, and the computing device actuates the mobile computing accessory to read the one or more RFID tags present in the scene via the trigger mechanism.

In an embodiment, the present disclosure is directed to a device. The device comprises a housing. The housing comprises a first portion and a second portion. The first portion has a computing unit integrated into a first surface of the first portion and a tab extending from a second surface of the first portion to facilitate grasping the device. The second surface opposes the first surface. The second portion has a radio frequency identification (RFID) antenna positioned within an interior of the second portion. The second portion extends at an acute angle from a proximal end of the first portion such that the housing is U-shaped. The acute angle by which the second portion extends from the proximal end of the first portion provides for viewing a scene via a display of the computing unit while reading one or more RFID tags present in the scene.

In accordance with an embodiment of the present disclosure, the first portion has at least one of a printed circuit board, a heat sink, or a battery positioned within an interior of the first portion.

In accordance with an embodiment of the present disclosure, the tab extends from the second surface of the first portion proximate to the proximal end of the first portion.

In accordance with an embodiment of the present disclosure, the acute angle by which the second portion extends from the proximal end of the first portion provides for an unobstructed field of view of an imaging assembly positioned on a posterior surface of a proximal end of the computing unit such that the imaging assembly extends beyond the proximal end of the first portion, and the device decodes an indicia imaged by the imaging assembly by actuating a button presented on the display of the computing unit.

In accordance with an embodiment of the present disclosure, the first portion has a distal end, the second portion has a distal end, and the distal end of the first portion and the distal end of the second portion stabilize the device in an upright position when positioned on a horizontal planar surface.

In accordance with an embodiment of the present disclosure, the device reads the one or more RFID tags present in the scene by actuating a button presented on the display of the computing unit.

In accordance with an embodiment of the present disclosure, the first portion has a trigger mechanism to actuate the device to read the one or more RFID tags present in the scene where the trigger mechanism is a depressible button.

In accordance with an embodiment of the present disclosure, the housing comprises a thermoplastic material, and the device is one or more of a barcode scanner or an RFID reader.

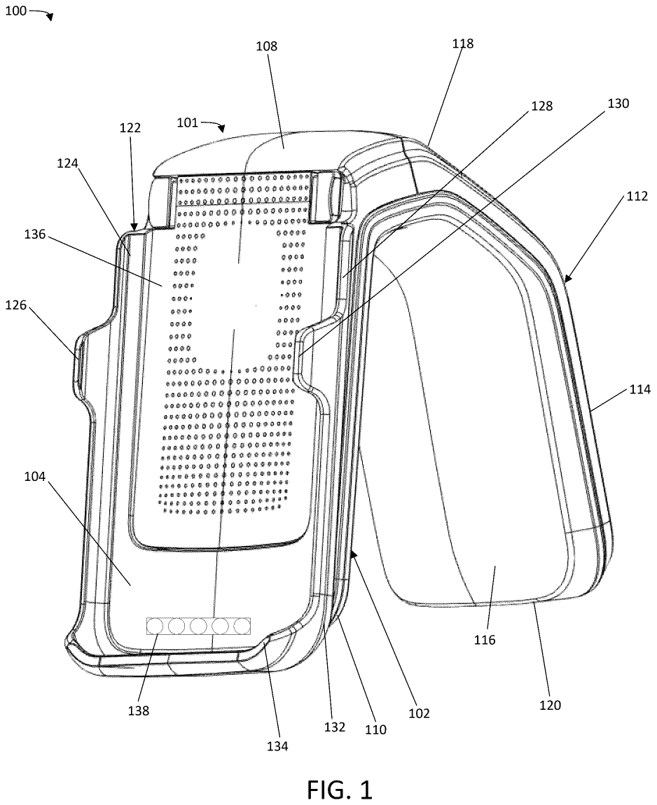

FIG. 1 illustrates a perspective view of a mobile computing accessory 100 in accordance with an embodiment of the present disclosure. The accessory 100 has a housing 101 comprising a first portion 102 and a second portion 112.

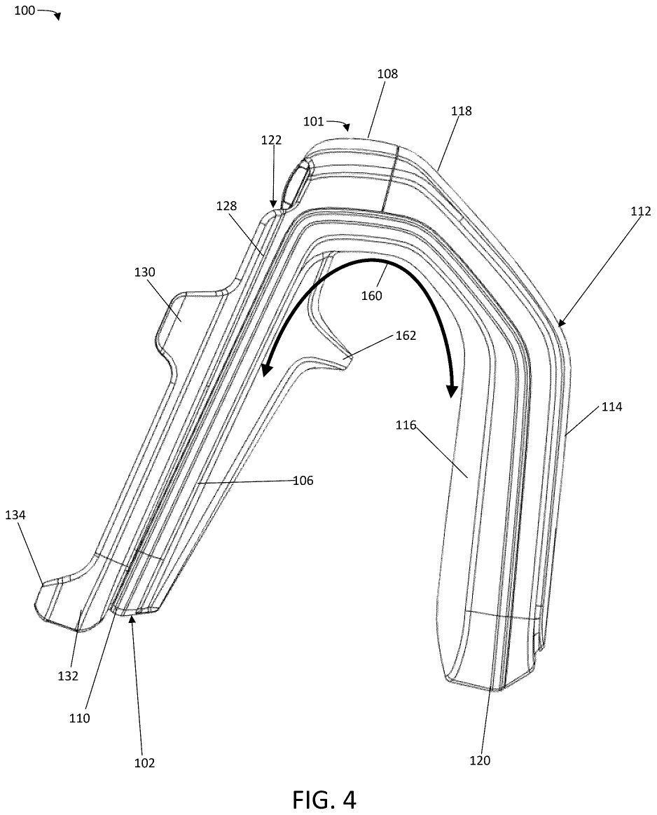

The first portion 102 has a first surface 104, a second surface 106 (e.g., as shown in FIGS. 4-6), a proximal end 108, and a distal end 110. The second surface 106 of the first portion 102 opposes the first surface 104 of the first portion 102.

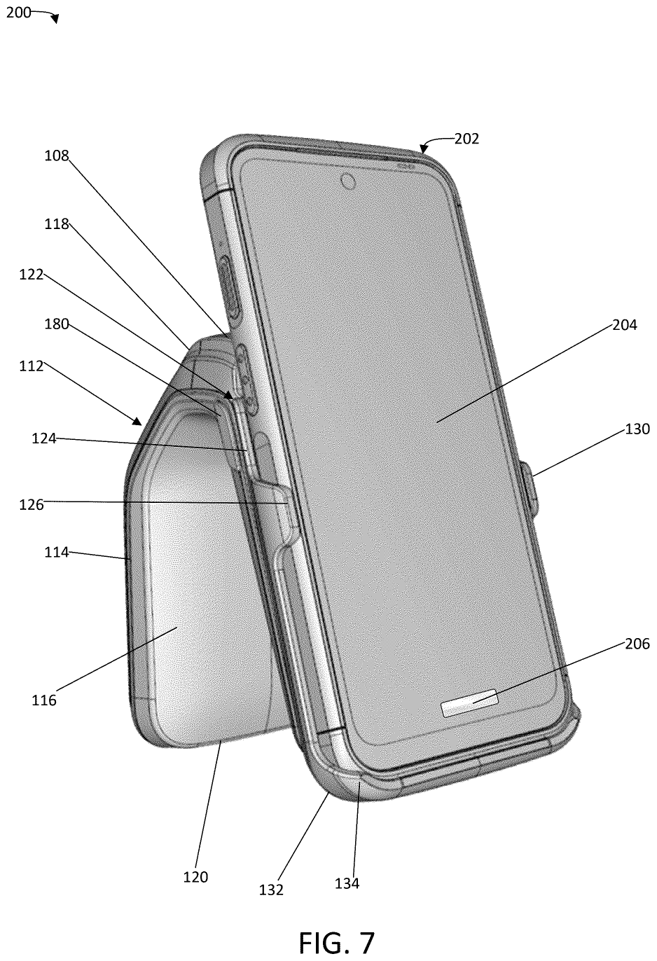

A mounting mechanism 122 extends from the first surface 104 of the first portion 102 and a tab 162 (e.g., as shown in FIGS. 4-6) extends from the second surface 106 of the first portion 102. The mounting mechanism 122 is configured to receive a detachable computing device 202 (e.g., as shown in FIGS. 7-9) and the tab 162 facilitates grasping (e.g., by a user) the accessory 100. The mounting mechanism 122 has a first side wall 124, a second side wall 128, and a bottom wall 132 that extend vertically from the first surface 104 of the first portion 102. The first side wall 124 has a first tab 126 extending from a portion of the first side wall 124 proximate to the proximal end 108 of the first portion 102. The second side wall 128 has a second tab 130 extending from a portion of the second side wall 128 proximate to the proximal end 108 of the first portion 102. The bottom wall has a third tab 134 extending from a length of the bottom wall 132 proximate to the distal end 110 of the first portion 102. In this way, the accessory 101 can fasten the detachable computing device 202 to the first surface 104 of the first portion 102 when the computing device 202 is mounted in the mounting mechanism 122.

The first surface 104 of the first portion 102 has contact pins 138. The accessory 100 may communicatively couple to the computing device 202 when mounted in the mounting mechanism 122 via the contact pins 138. Alternatively, the accessory 100 may communicatively couple to the computing device 202 when mounted in the mounting mechanism 122 via wireless communication pairing (e.g., Bluetooth®) or any suitable wireless communication protocol.

The first surface 104 of the first portion 102 has a recess 136 configured to receive a battery (not shown). As shown in FIG. 1, the recess 136 may be substantially rectangular but may be any suitable shape. The battery may be a lithium-ion battery or any suitable battery.

The second portion 112 has a first surface 114, a second surface 116, a proximal end 118 and a distal end 120. The second surface 116 of the second portion 112 opposes the first surface 114 of the second portion 112.

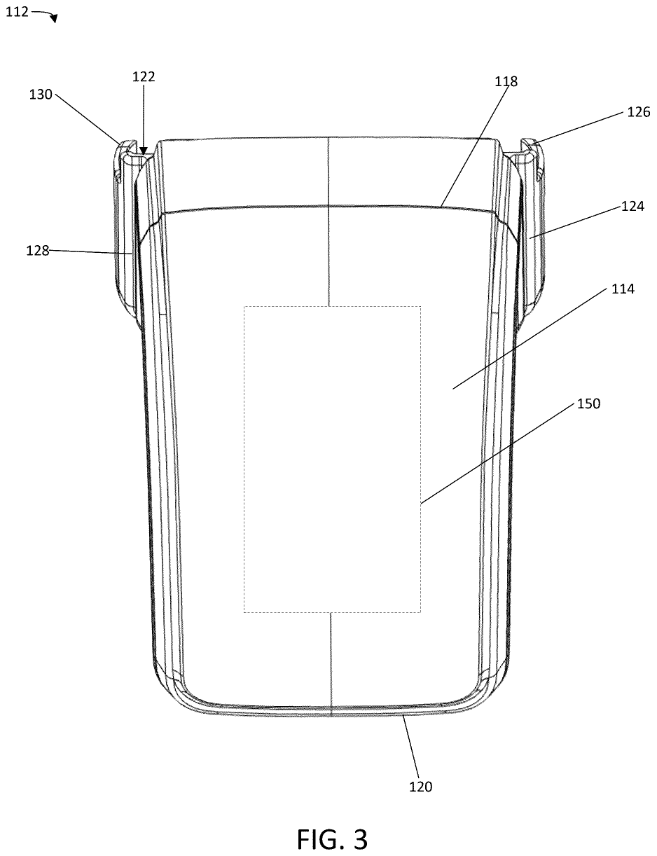

The second portion 112 has a RFID antenna 150 (as shown in FIG. 3) positioned within an interior of the second portion 112. As shown in FIG. 1, the second portion 112 extends at an acute angle from the proximal end 108 of the first portion 102 such that the housing 101 is U-shaped.

The housing 101 may comprises a thermoplastic material or any suitable material. For example, polymers used to form the housing 101 can include, but are not limited to, polyesters, silicones, polyimides, polyurethanes, thermoplastic and/or vinyl polymers, such as polycarbonate, polypropylene, polyethylene, polyethylene terephthalate, nylon, polyvinyl fluoride, and/or Tyvek®, other materials, and/or any combination thereof. As described in further detail below, the acute angle by which the second portion 112 extends from the proximal end 108 of the first portion 102 provides for viewing a scene via a display 204 (as shown in FIG. 7) of the computing device 202 when mounted in the mounting mechanism 122 while reading one or more RFID tags present in the scene.

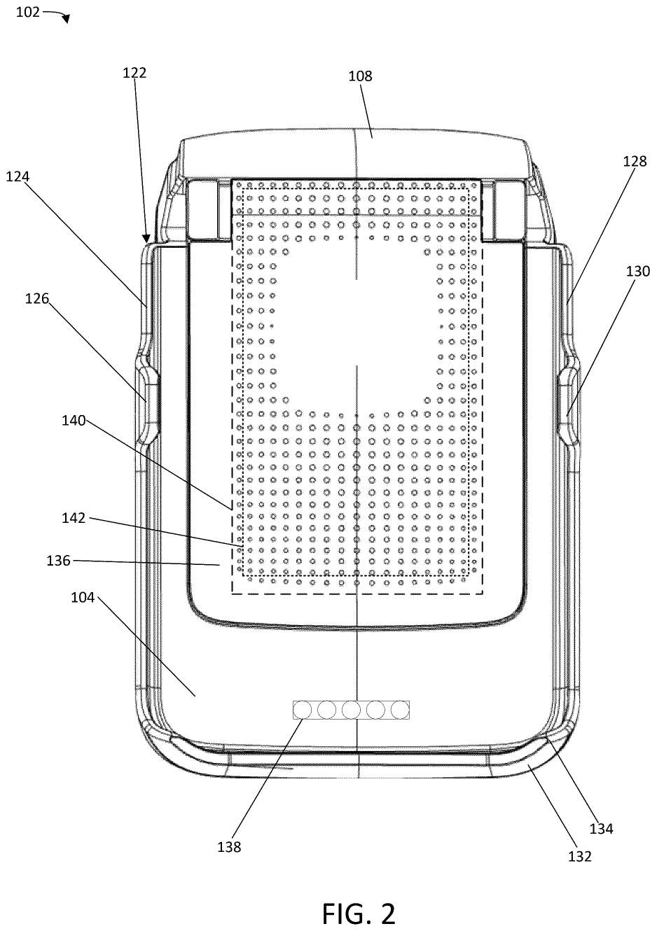

FIG. 2 illustrates a front view of the mobile computing accessory 100 of FIG. 1. For example, FIG. 2 illustrates a front view of the first portion 102. As shown in FIG. 2, the first portion 102 may have one or more of a heat sink 140 and a printed circuit board 142 positioned within an interior of the first portion 102. The heat sink 140 and the printed circuit board 142 may be any suitable shape and size and need not be configured to fit within the recess 136. Additionally, a battery (not shown) may be positioned within the interior of the first portion 102 instead of within the recess 136 or in addition to a battery positioned in the recess 136. For example, a backup battery may be positioned within the interior of the first portion 102 in addition to a battery positioned in the recess 136.

The first portion 102 and/or the printed circuit board 142 may contain or support one or more components of the accessory 100 including, for example, a logic circuit, memory, a communication interface (e.g., for wired and wireless communication), input/output (I/O) devices (e.g., switches, buttons, speakers, microphone, etc.), and a sensor. The logic circuit can include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. The memory may be a non-transitory computer-readable medium that can include, for example, volatile (e.g., RAM, DRAM, SRAM, etc.) and/or non-volatile memory (e.g., ROM, PROM, EPROM, EEPROM, Flash memory device, optical memory device, magnetic memory device). The logic circuit can be operatively coupled to the memory, the communications interface, the I/O devices, and/or the sensor. In one example, the logic circuit can be configured to execute code stored in the memory to perform operations and functions associated with decoding one or more indicia and/or reading one or more RFID tags.

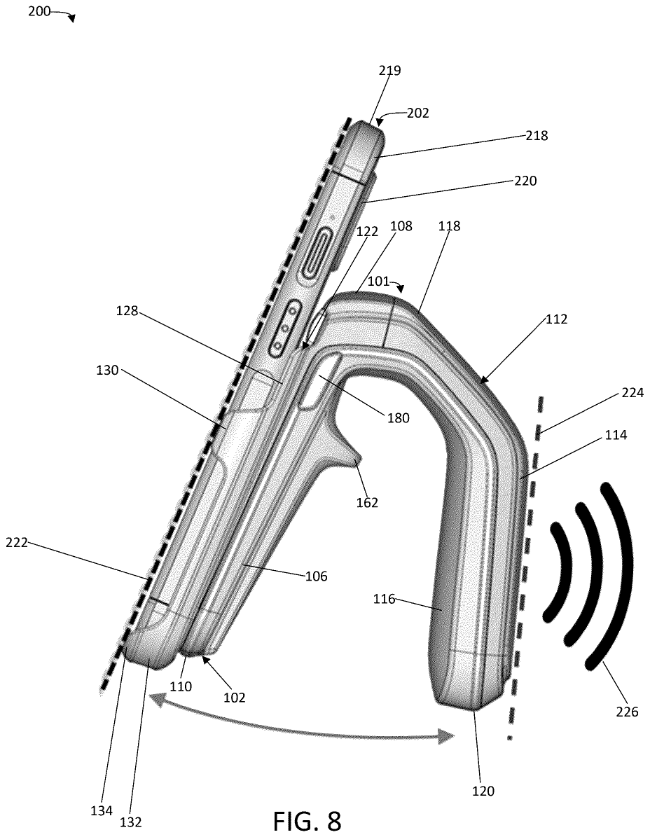

FIG. 3 illustrates a rear view of the mobile computing accessory 100 of FIG. 1. For example, FIG. 3 illustrates a front view of the second portion 112. As shown in FIG. 3, the second portion 112 has a RFID antenna 150 (as shown in FIG. 3) positioned within an interior of the second portion 112. The RFID antenna 150 emits a radiation pattern 226 (as shown in FIG. 8) directed through and away from the first surface 114 of the second portion 112 when reading one or more RFID tags. The RFID antenna 150 may be any suitable shape or size to read RFID tags.

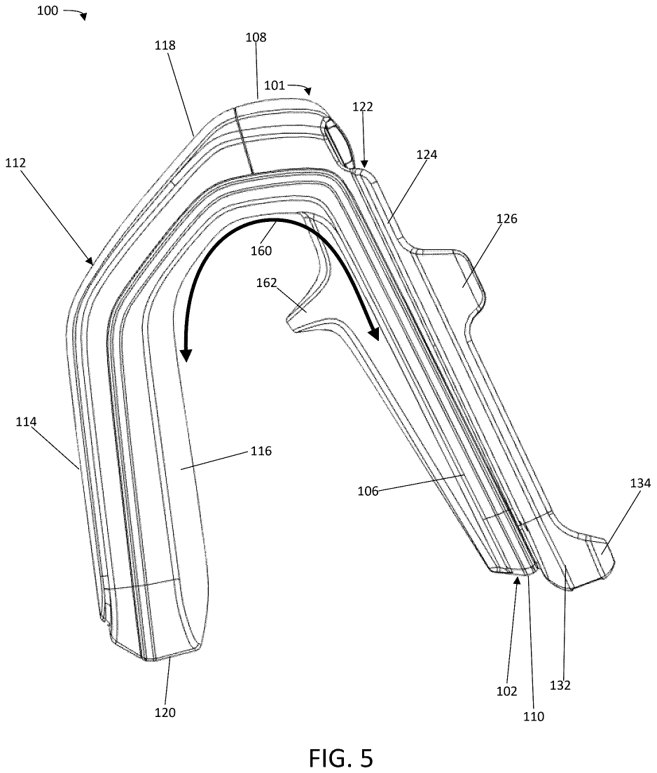

FIG. 4 illustrates a side view of the mobile computing accessory 100 of FIG. 1 and FIG. 5 illustrates another side view of the mobile computing accessory 100 of FIG. 1. As shown in FIGS. 4 and 5, the second portion 112 extends at an acute angle from the proximal end 108 of the first portion 102 such that the housing 101 is U-shaped as denoted by the U-shaped arrow 160. The tab 162 extends from the second surface 160 of the first portion 102 proximate to the proximal end 108 of the first portion 102. The tab 162 facilitates grasping (e.g., by a user) the accessory 100.

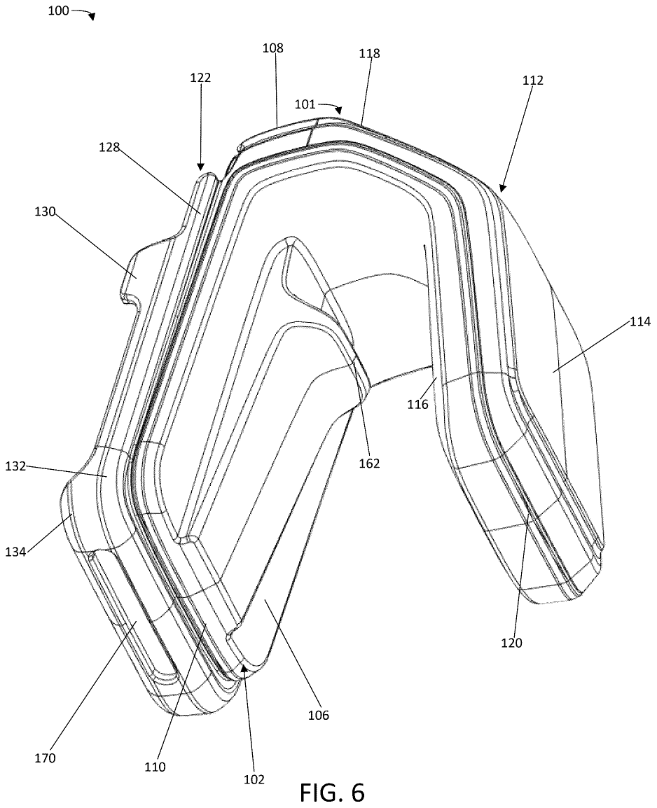

FIG. 6 illustrates a bottom view of the mobile computing accessory 100 of FIG. 1. As shown in FIG. 6, the third tab 134 of the bottom wall 132 has a cylindrical aperture 170. The aperture 170 may facilitate air flow to and/or heat dissipation from the computing device 202 when mounted in the mounting mechanism 122 and may be any suitable shape and/or size.

FIG. 7 illustrates a perspective view of a mobile computing accessory 100 in accordance with another embodiment of the present disclosure. As shown in FIG. 7, a computing device 202 is mounted in the mounting mechanism 122 of the accessory 100 and is communicatively coupled to the accessory 100 via at least one of wireless communication pairing (e.g., Bluetooth®) or any suitable wireless communication protocol or the contact pins 138 (not shown). The computing device 202 has at least a display 204 and a button 206 presented on the display 204. The display may be a touchscreen and the button may be a haptic touch button. The distal end 110 of the first portion and the distal end 120 of the second portion stabilize the accessory 100 in an upright position when positioned on a horizontal planar surface. The accessory 100 has a trigger mechanism 180. The trigger mechanism 180 may include, but is not limited to, a depressible button, a switch, or a touch sensor (e.g., a capacitive touch sensor). The computing device 202 may actuate the accessory 100 to read one or more RFID tags present in a scene displayed on the display 204 via the trigger mechanism 180. Additionally or alternatively, the computing device 202 may actuate the accessory 100 to read one or more RFID tags present in a scene displayed on the display 204 via the button 206 presented on the display 204.

FIG. 8 illustrates a side view of the mobile computing accessory 100 of FIG. 7. As shown in FIG. 8, the computing device 202 is mounted in the mounting mechanism 122 of the accessory 100 and is communicatively coupled to the accessory 100 via at least one of wireless communication pairing (e.g., Bluetooth®) or any suitable wireless communication protocol or the contact pins 138 (not shown). The computing device 202 has an imaging assembly 220. The imaging assembly 220 is positioned on a posterior surface 218 of a proximal end 219 of the computing device 202 when received by the mounting mechanism 122 such that the imaging assembly 220 extends beyond the proximal end 108 of the first portion 102. The acute angle by which the second portion 112 extends from the proximal end 108 of the first portion 102 provides for viewing a scene via a display 204 (as shown in FIG. 7) of the computing device 202 when mounted in the mounting mechanism 122 while reading one or more RFID tags present in the scene. For example, the plane 222 of the display 204 of the computing device 202 and the plane 224 of the first surface 114 of the second portion 112 are not orthogonal such that one or more RFID tags present in a scene can be read via the radiation pattern 226 emitted by the RFID antenna 150 while the scene is displayed on the display 204 of the computing device 202. The computing device 202 may actuate the accessory 100 to read one or more RFID tags present in a scene displayed on the display 204 via the trigger mechanism 180. Additionally or alternatively, the computing device 202 may actuate the accessory 100 to read one or more RFID tags present in a scene displayed on the display 204 via the button 206 presented on the display 204. In this way, a user operating the accessory 100 and computing device 202 need not oscillate between tilting the accessory and computing device 202 at different angles to view the display 204 of the computing device 202 while reading RFID tags. Additionally, the center of gravity of the accessory 100 and computing device 202 is proximate to a user which mitigates, if not eliminates, fatigue in the hand and wrist of a user.

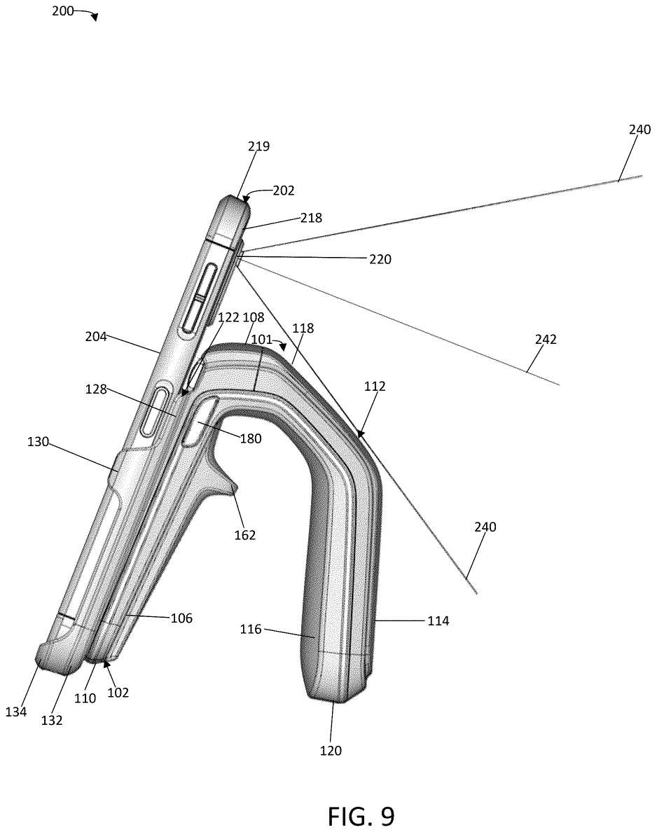

FIG. 9 illustrates a side view of the mobile computing accessory of FIG. 7. As shown in FIG. 9, the computing device 202 is mounted in the mounting mechanism 122 of the accessory 100 and is communicatively coupled to the accessory 100 via at least one of wireless communication pairing (e.g., Bluetooth®) or any suitable wireless communication protocol or the contact pins 138 (not shown). The computing device 202 has an imaging assembly 220. The imaging assembly 220 is positioned on a posterior surface 218 of a proximal end 219 of the computing device 202 when received by the mounting mechanism 122 such that the imaging assembly 220 extends beyond the proximal end 108 of the first portion 102. The acute angle by which the second portion 112 extends from the proximal end 108 of the first portion 102 provides for an unobstructed field of view 240 and line of sight 242 of the imaging assembly 220 of the computing device 202. For example, the acute angle by which the second portion 112 extends from the proximal end 108 of the first portion 102 provides for viewing a scene via a display 204 (as shown in FIG. 7) of the computing device 202 when mounted in the mounting mechanism 122 while imaging and decoding indicia present in the scene and within the field of view 240 of the imaging assembly 220. The computing device 202 may actuate the accessory 100 to image and decode indicia present in the scene displayed on the display 204 via the trigger mechanism 180. Additionally or alternatively, the computing device 202 may actuate the accessory 100 to decode indicia present in the scene displayed on the display 204 via the button 206 presented on the display 204. In this way, a user operating the accessory 100 and computing device 202 need not oscillate between tilting the accessory and computing device 202 at different angles to view the display 204 of the computing device 202 while imaging and decoding indicia. Additionally, the center of gravity of the accessory 100 and computing device 202 is proximate to a user which mitigates, if not eliminates, fatigue in the hand and wrist of a user.

FIGS. 7-9 illustrate a detachable computing device 202 mounted in the mounting mechanism 122 of the accessory 100. In an embodiment, the computing device 202 may be integrated with the accessory 100. For example, in an embodiment the present disclosure is directed to a device (e.g., a barcode scanner and/or an RFID reader). The device comprises a housing. The housing comprises a first portion and a second portion. The first portion has a computing unit integrated into a first surface of the first portion and a tab extending from a second surface of the first portion to facilitate grasping the device. The second surface opposes the first surface. The second portion has an RFID antenna positioned within an interior of the second portion. The second portion extends at an acute angle from a proximal end of the first portion such that the housing is U-shaped. The acute angle by which the second portion extends from the proximal end of the first portion provides for viewing a scene via a display of the computing unit while reading one or more RFID tags present in the scene. Additionally, the acute angle by which the second portion extends from the proximal end of the first portion provides for an unobstructed field of view of an imaging assembly positioned on a posterior surface of a proximal end of the computing unit such that the imaging assembly extends beyond the proximal end of the first portion. The device may read one or more RFID tags present in the scene by actuating a button presented on the display of the computing unit and/or decode indicia imaged by the imaging assembly by actuating a button presented on the display of the computing unit.

The above description refers to diagrams of the accompanying drawings. Alternative implementations of the example represented by the diagrams include one or more additional or alternative elements, processes, and/or devices. Additionally, or alternatively, one or more of the example elements of the diagram may be combined, divided, re-arranged, or omitted.

The above description refers to a block diagram of the accompanying drawings. Alternative implementations of the example represented by the block diagram includes one or more additional or alternative elements, processes, and/or devices. Additionally, or alternatively, one or more of the example blocks of the diagram may be combined, divided, re-arranged, or omitted. Components represented by the blocks of the diagram are implemented by hardware, software, firmware, and/or any combination of hardware, software, and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged, or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. A mobile computing accessory comprising:
a housing comprising
a first portion having a mounting mechanism extending from a first surface of the first portion and configured to receive a detachable computing device, and a tab extending from a second surface of the first portion to facilitate grasping the mobile computing accessory, the second surface opposing the first surface, and
a second portion having a radio frequency identification (RFID) antenna positioned within an interior of the second portion, wherein
the second portion extends at an acute angle from a proximal end of the first portion such that the housing is U-shaped, and
the acute angle by which the second portion extends from the proximal end of the first portion provides for viewing a scene via a display of the computing device mounted in the mounting mechanism while reading one or more RFID tags present in the scene.

2. The mobile computing accessory of claim 1, wherein the first surface of the first portion has a recess configured to receive a battery.

3. The mobile computing accessory of claim 1, wherein the mounting mechanism has a first side wall, a second side wall, and a bottom wall that extend vertically from the first surface of the first portion.

4. The mobile computing accessory of claim 3, wherein
the first side wall has a first tab extending from a portion of the first side wall proximate to the proximal end of the first portion,
the second side wall has a second tab extending from a portion of the second side wall proximate to the proximal end of the first portion, and
the bottom wall has a third tab extending from a length of the bottom wall proximate to a distal end of the first portion.

5. The mobile computing accessory of claim 1, wherein the first portion has at least one of a printed circuit board, a heat sink, or a battery positioned within an interior of the first portion.

6. The mobile computing accessory of claim 1, wherein the tab extends from the second surface of the first portion proximate to the proximal end of the first portion.

7. The mobile computing accessory of claim 1, wherein the acute angle by which the second portion extends from the proximal end of the first portion provides for an unobstructed field of view of an imaging assembly positioned on a posterior surface of a proximal end of the computing device when received by the mounting mechanism, the imaging assembly extending beyond the proximal end of the first portion.

8. The mobile computing accessory of claim 1, wherein the housing comprises a thermoplastic material.

9. The mobile computing accessory of claim 1, wherein
the first portion has a distal end,
the second portion has a distal end, and
the distal end of the first portion and the distal end of the second portion stabilize the mobile computing accessory in an upright position when positioned on a horizontal planar surface.

10. The mobile computing accessory of claim 1, wherein the mobile computing accessory communicatively couples to the computing device when mounted in the mounting mechanism by at least one of wireless communication pairing or contact pins.

11. The mobile computing accessory of claim 10, wherein the computing device actuates the mobile computing accessory to read the one or more RFID tags present in the scene via a button presented on the display of the computing device.

12. The mobile computing accessory of claim 10, wherein
the first portion has a trigger mechanism, the trigger mechanism being a depressible button, and
the computing device actuates the mobile computing accessory to read the one or more RFID tags present in the scene via the trigger mechanism.

13. A device comprising:
a housing comprising
a first portion having a computing unit integrated into a first surface of the first portion and a tab extending from a second surface of the first portion to facilitate grasping the device, the second surface opposing the first surface, and
a second portion having a radio frequency identification (RFID) antenna positioned within an interior of the second portion, wherein
the second portion extends at an acute angle from a proximal end of the first portion such that the housing is U-shaped, and
the acute angle by which the second portion extends from the proximal end of the first portion provides for viewing a scene via a display of the computing unit while reading one or more RFID tags present in the scene.

14. The device of claim 13, wherein the first portion has at least one of a printed circuit board, a heat sink, or a battery positioned within an interior of the first portion.

15. The device of claim 13, wherein the tab extends from the second surface of the first portion proximate to the proximal end of the first portion.

16. The device of claim 13, wherein
the acute angle by which the second portion extends from the proximal end of the first portion provides for an unobstructed field of view of an imaging assembly positioned on a posterior surface of a proximal end of the computing unit such that the imaging assembly extends beyond the proximal end of the first portion, and
the device decodes an indicia imaged by the imaging assembly by actuating a button presented on the display of the computing unit.

17. The device of claim 13, wherein
the housing comprises a thermoplastic material, and
the device is one or more of a barcode scanner or an RFID reader.

18. The device of claim 13, wherein
the first portion has a distal end,
the second portion has a distal end, and
the distal end of the first portion and the distal end of the second portion stabilize the device in an upright position when positioned on a horizontal planar surface.

19. The device of claim 13, wherein the device reads the one or more RFID tags present in the scene by actuating a button presented on the display of the computing unit.

20. The device of claim 13, wherein the first portion has a trigger mechanism to actuate the device to read the one or more RFID tags present in the scene, wherein the trigger mechanism is a depressible button.
